(19) United States
(12) Patent Application Publication
(10) Pub. No.: US 2026/0223175 A1
(43) Pub. Date: Jul. 30, 2026

(54) MEASUREMENT METHOD AND DEVICE

(71) Applicant: GUANGDONG OPPO MOBILE TELECOMMUNICATIONS CORP., LTD., Dongguan (CN)

(72) Inventors: Jinyu ZHANG, Dongguan (CN); Rongyi HU, Dongguan (CN)

(21) Appl. No.: 19/572,320

(22) Filed: Mar. 19, 2026

Related U.S. Application Data
(63) Continuation of application No. PCT/CN2023/129767, filed on Nov. 3, 2023.

(51) Int. Cl. H04W 74/0816; H04W 8/22

(52) U.S. Cl. CPC H04W 74/0816; H04W 8/22

(57) ABSTRACT

Provided is a measurement method. The method is performed by a user equipment (UE), and includes: determining a measurement mode for a measurement object (MO) in a case where a first measurement gap (MG) is deactivated; wherein the UE is configured with at least two MGs, wherein the at least two MGs include the first MG, and the first MG is an associated MG for the MO.

### CROSS-REFERENCE TO RELATED APPLICATION

This application is a continuation of International Application No. PCT/CN2023/129767, filed Nov. 3, 2023, the entire disclosure of which is incorporated herein by reference.

### TECHNICAL FIELD

The present disclosure relates to the field of communications, and in particular, relates to a measurement method and apparatus, and a device and a storage medium thereof.

### RELATED ART

In a case where a user equipment (UE) is configured with a plurality of concurrent gaps, when a measurement gap (MG) associated with a measurement object (MO) is deactivated, measurement behavior of the UE for the MO remains undefined.

### SUMMARY

Embodiments of the present disclosure provide a measurement method and apparatus, and a device and a storage medium thereof. The technical solutions are as follows.

According to some embodiments of the present disclosure, a measurement method is provided. The method is performed by a UE. The method includes:

determining a measurement mode for an MO in a case where a first MG is deactivated.

The UE is configured with at least two MGs. The at least two MGs include the first MG. The first MG is an associated MG for the MO.

According to some embodiments of the present disclosure, a UE is provided. The UE includes: a processor; a transceiver, communicably connected to the processor; and a memory, configured to store one or more executable instructions of the processor, wherein the processor is configured to load and execute the one or more executable instructions to cause the UE to perform the measurement method as described above.

According to an aspect of the present disclosure, a network device is provided. The network device includes: a processor; a transceiver, communicably connected to the processor; and a memory, configured to store one or more executable instructions of the processor, wherein the processor is configured to load and execute the one or more executable instructions to cause the network device to perform the measurement method as described above.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a mobile communication system according to some exemplary embodiments of the present disclosure;

FIG. 2 is a schematic flowchart of a measurement method according to some exemplary embodiments of the present disclosure;

FIG. 3 is a schematic flowchart of a measurement method according to some exemplary embodiments of the present disclosure;

FIG. 4 is a schematic diagram of an overlap status according to some exemplary embodiments of the present disclosure;

FIG. 5 is a schematic diagram of an overlap status according to some exemplary embodiments of the present disclosure;

FIG. 6 is a schematic diagram of an overlap status according to some exemplary embodiments of the present disclosure;

FIG. 7 is a schematic flowchart of a measurement method according to some exemplary embodiments of the present disclosure;

FIG. 8 is a structural block diagram of a measurement apparatus according to some exemplary embodiments of the present disclosure;

FIG. 9 is a structural block diagram of a measurement apparatus according to some exemplary embodiments of the present disclosure; and

FIG. 10 is a schematic structural diagram of a communication device according to some exemplary embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings. Reference is made in detail to the embodiments, examples of which are illustrated in the accompanying drawings. When the following description refers to the accompanying drawings, the same numbers in different accompanying drawings represent the same or similar elements unless otherwise indicated. The embodiments described in the following embodiments do not represent all embodiments consistent with the present disclosure. Rather, they are merely examples of apparatus and methods consistent with some aspects of the present disclosure, as detailed in the appended claims.

The terms used in the present disclosure are for the purpose of describing particular embodiments only and are not intended to be limiting to the present disclosure. As used in the present disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items.

It should be understood that although the terms “first,” “second,” “third,” or the like may be used in the present disclosure to describe various information, such information should not be limited to these terms. These terms are only used to distinguish one type of information from another. For example, first information may also be referred to as second information, and similarly, second information may also be referred to as first information, without departing from the scope of the present disclosure. The word “if”, as used herein, may be interpreted as “in a case where,” “in a case of,” or “in response to determining that,” depending on the context.

First, communication technologies involved in the embodiments of the present disclosure are described:

### MG:

When a UE needs to perform measurement behavior, it may face a situation that a center frequency of a current cell is different from a center frequency of a target cell, or that a communication system of the current cell is different from a communication system of the target cell. To perform the measurement behavior in both situations, a simple way is to install two types of radio frequency (RF) receivers in the UE to respectively measure the current cell and the target cell. However, this results in higher costs and interference between different frequencies.

Therefore, the MG is proposed to solve this problem. Within the MG, the UE does not perform data transmission with the current cell, but adjusts an RF receiver to a target frequency for measuring the target cell. Upon elapse of a time period of the MG, the RF receiver is adjusted back to the frequency of the current cell.

### Pre-Configured MG (Pre-MG):

For an MO, whether an MG is needed or not for measurement may change. For example, an intra-frequency MO is within bandwidth of a bandwidth part (BWP) 1 and outside bandwidth of a BWP 2. In a case where an active BWP of UE is the BWP 1, the MO can be measured without an MG. In a case where the active BWP of the UE is the BWP 2, an MG is required for measurement of the MO. Such a change in a requirement for an MG may be quickly triggered by underlying signaling. For example, BWP switching may be indicated by downlink control information (DCI).

However, MG configuration or modification is usually implemented through radio resource control (RRC) signaling. To rapidly adjust state transitions of the MG, a pre-MG enhancement method is introduced to activate or deactivate the pre-MG. When the MO needs to be measured within an MG, the pre-MG is activated, and the pre-MG is used almost identically to a common MG. When the MO does not need to be measured within an MG, the pre-MG is deactivated. In this case, the MO is measured outside gap, which is equivalent to not configuring an MG for the MO.

There are the following two types of activation/deactivation mechanisms for the pre-MG:

### 1. Autonomous Activation or Deactivation by the UE

When a trigger event occurs, the UE autonomously determines a status of the pre-MG. In a case where none of configured MOs needs an MG, the UE autonomously deactivates the pre-MG. In a case where one or more MOs need an MG, the UE autonomously activates the pre-MG. For example, the trigger event includes one or more of BWP switching, secondary cell (SCell) activation, SCell deactivation, SCell addition, SCell release, SCell modification, MO addition, MO modification, or the like.

2. Activation or Deactivation Based on Signaling from a Network Device

The network device indicates a configured status of the pre-MG (for example, a bit value of “1” indicates activated, and a bit value of “0” indicates deactivated). The status of the pre-MG is indicated per component carrier (per CC) and per BWP. In a case where the status of the pre-MG corresponding to a currently activated BWP on all CCs is deactivated, the pre-MG is deactivated. In a case where the status of the pre-MG corresponding to the currently activated BWP on one or more CCs is activated, the pre-MG is activated.

### Concurrent Gaps:

The pre-MG discussed above is for one MG. For example, the pre-MG is a per-UE MG, that is, each UE is configured with one MG. Alternatively, the pre-MG is a per-frequency range (per-FR) MG, that is, one MG is configured for each FR.

Further, it may be considered to configure a plurality of concurrent gaps for the UE. For example, a plurality of per-UE MGs are configured for the UE. Alternatively, a plurality of per-FR MGs are configured for one FR. One or more pre-MGs exist in the plurality of concurrent gaps, and can be adaptively activated or deactivated. In addition, the network device configures an associated MG for an MO to ensure that an MG used for measurement of the MO is determined. For example, configurations of concurrent gaps are shown in Table 1.

TABLE 1
The number of gap combination configurations for UE supporting
concurrent MG patterns and independent MG patterns

| Gap combination | The number of simultaneous configured MG patterns | | |
|---|---|---|---|
| configuration ID | Per-FR1 MG | Per-FR2 MG | Per-UE MG |
| 0 | 2 | 1 | 0 |
| 1 | 1 | 2 | 0 |
| 2 | 0 | 0 | 2 |
| 3 | 1 | 0 | 1 |
| 4 | 0 | 1 | 1 |
| 5 | 1 | 1 | 1 |
| 6 | 2 | 0 | 0 |
| 7 | 0 | 2 | 0 |

Gap combinations with gap combination configuration IDs 3, 4, and 5 are applied only when a per-UE MG is associated with positioning reference signal (PRS) measurement for one or more of a reference signal time difference (RSTD), a reference signal received power (RSRP), a UE Rx-Tx time difference, or the like. For details, reference may be made to relevant content in 3rd Generation Partnership Project (3GPP) TS 38.215 [4] (Gap Combination Configuration Id #3, #4, #5 will be only applied when the per-UE measurement gap is associated to measure PRS for any RSTD, PRS-RSRP, and UE Rx-Tx time difference measurement defined in TS 38.215 [4]).

For gap combinations with gap combination configuration IDs 0, 1, 6, and 7, in a case where the UE supports independent gap configuration (independentGapConfigPRS-r17), one per-FR MG within an FR is associated with PRS measurement for one or more of an RSTD, an RSRP, or a UE Rx-Tx time difference. For details, reference may be made to relevant content in 3GPP TS 38.215 [4] (In Gap Combination Configuration Id #0, #1, #6, #7, one per-FR measurement gap in an FR can be associated to measure PRS for any RSTD, PRS-RSRP, and UE Rx-Tx time difference measurement defined in TS 38.215 [4] provided that UE supports independentGapConfigPRS-r17).

In a case where the UE is configured with a plurality of concurrent gaps, when an MG associated with an MO is deactivated, measurement behavior of the UE for the MO remains undefined. For example, problems such as whether to measure the MO, whether to measure the MO by using an MG, and which MG to use for measuring the MO remain unsolved.

The present disclosure provides a measurement method and apparatus, and a device and a storage medium, to provide a specific and feasible solution for measurement behavior when a first MG associated with an MO is deactivated.

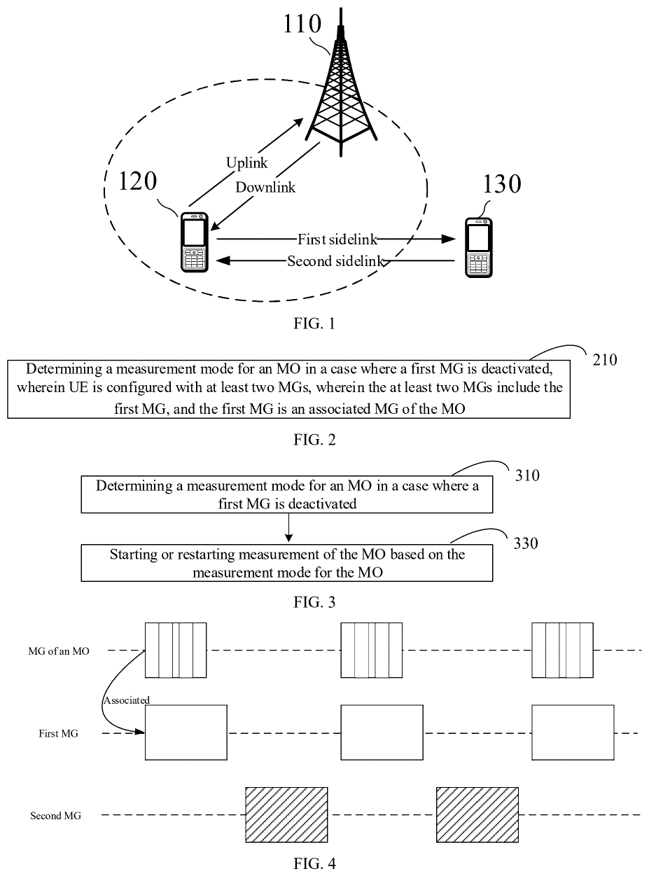

FIG. 1 illustrates a schematic diagram of a mobile communication system according to some embodiments of the present disclosure. The mobile communication system includes a network device 110 and a UE 120, and may further include or not include a UE 130, which is not limited in the present disclosure.

The network device 110 in the present disclosure provides wireless communication functions. The network device includes but not limited to: an evolved Node-B (eNB), a radio network controller (RNC), a Node-B (NB), a base station controller (BSC), a base transceiver station (BTS), a home base station (e.g., a home evolved Node-B, or a home Node-B, HNB), a baseband unit (BBU), an access point (AP) in a wireless fidelity (Wi-Fi) system, a wireless relay node, a wireless backhaul node, a transmission point (TP) or a transmission and reception point (TRP), or the like. It may also be a next generation Node-B (gNB) or a transmission reception point (a TRP or a TP) in a 5th generation (5G) mobile communication system, or one or a set of antenna panels (including a plurality of antenna panels) of a base station in the 5G system, or a network node constituting a gNB or a transmission point, such as a baseband unit (BBU) or a distributed unit (DU), or the like, or a base station in a beyond 5th generation (B5G), a 6th generation (6G) mobile communication system, or the like, or a core network (CN), a fronthaul, a backhaul, a radio access network (RAN), a network slice, or the like, or a serving cell, a primary cell (PCell), a primary secondary cell (PSCell), a special Cell (SpCell), a secondary cell (SCell), a neighbor cell, or the like, of the UE.

The UE 120 in the present disclosure is also referred to as a terminal device, an access terminal, a user unit, a user station, a mobile station, a mobile terminal, a remote station, a remote terminal, a mobile device, a user terminal, a terminal, a wireless communication device, a user agent, a user device. The terminal includes but is not limited to: a handheld device, a wearable device, an in-vehicle device, an Internet of things device, or the like, such as: a mobile phone, a tablet, an e-book reader, a laptop, a desktop computer, a television, a game console, a mobile Internet device (MID), an augmented reality (AR) terminal, a virtual reality (VR) terminal, and a mixed reality (MR) terminal, an extended reality (XR) terminal, a baffle reality (BR) terminal, a cinematic reality (CR) terminal, a deceive reality (DR) terminal, a wearable device, a handle, an electronic tag, a controller, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, a wireless terminal in remote medical surgery, a cellular phone, a cordless phone, a Session Initiation Protocol (SIP) phone, a wireless local loop (WLL) station, a personal digital assistant (PDA), a set-top box (STB), a customer premises equipment (CPE), or the like.

In some embodiments, the network device 110 and the UE 120 communicate with each other using an air interface technology, such as a Uu interface.

In some embodiments, there are two types of communication scenarios between the network device 110 and the UE 120: an uplink communication scenario and a downlink communication scenario. Uplink communication, also referred to as uplink transmission, refers to transmitting signals or data to the network device 110; downlink communication, also referred to as downlink transmission, refers to transmitting signals or data to the UE 120.

In some embodiments, the UE 120 and the UE 130 communicate with each other using an air interface technology, such as a PC5 interface.

In some embodiments, there are two types of communication scenarios between the UE 120 and the UE 130: a first sidelink communication scenario and a second sidelink communication scenario. The first sidelink communication refers to transmitting signals to the UE 130; the second sidelink communication refers to transmitting signals to the UE 120.

In some embodiments, the UE 120 and the UE 130 are both within network coverage and located in the same cell, or the UE 120 and the UE 130 are both within network coverage but located in different cells, or the UE 120 is within network coverage, but the UE 130 is outside network coverage.

The technical solutions according to the embodiments of the present disclosure may be applied to various communication systems, such as: a global system of mobile communication (GSM) system, a code-division multiple access (CDMA) system, a wideband code-division multiple access (WCDMA) system, a general packet radio service (GPRS) system, a long-term evolution (LTE) system, a frequency division duplex (FDD) system, a time-division duplex (TDD) system, a cross division duplex (XDD) system, an advanced long-term evolution (LTE-A) system, a universal mobile telecommunication system (UMTS), a worldwide interoperability for microwave access (WiMAX) communication system, a 5G mobile communication system, a new radio (NR) system, an evolved system of the NR system, an LTE-based access to unlicensed spectrum (LTE-U) system, an NR-based access to unlicensed spectrum (NR-U) system, a terrestrial network (TN) system, a non-terrestrial network (NTN) system, a wireless local area network (WLAN) system, a wireless fidelity (Wi-Fi) system, a cellular Internet of things (IoT) system, a cellular passive Internet of things system, and may also be applied to the subsequent evolution systems of 5G NR system, and may also be applied to B5G, 6G, and subsequent evolution systems. In some embodiments of the present disclosure, “NR” may also be referred to as 5G NR system or 5G system. Among them, the 5G mobile communication system may include non-standalone (NSA) and/or standalone (SA).

The technical solutions provided by the embodiments of the present disclosure may also be applied to a machine-type communications (MTC), a long-term evolution-machine (LTE-M), a device-to-device (D2D) network, a machine-to-machine (M2M) network, an IoT network, or other networks. The IoT network may include an Internet of vehicles. The communication methods in the Internet of vehicles system are collectively referred to as vehicle-to-X (V2X, X represents anything). For example, the V2X may include: vehicle-to-vehicle (V2V) communications, vehicle-to-infrastructure (V2I) communications, vehicle-to-pedestrian (V2P) communications, vehicle-to-network (V2N) communications, or the like.

The mobile communication system according to the embodiments of the present disclosure is applicable to, but is not limited to, at least one of: an uplink communication scenario, a downlink communication scenario, or a sidelink communication scenario.

FIG. 2 is a schematic flowchart of a measurement method according to some exemplary embodiments of the present disclosure. An example in which the method is performed by UE is used for schematic description. The UE may be implemented as the UE 120 shown in FIG. 1. The method includes at least one of the following processes.

In process 210, a measurement mode for an MO is determined in a case where a first MG is deactivated. The UE is configured with at least two MGs. The at least two MGs include the first MG. The first MG is an associated MG for the MO.

In some embodiments, the first MG is an associated MG for the MO, which may also be understood as that the MO is associated with the first MG.

In some embodiments, the first MG is a pre-MG.

In some embodiments, the at least two MGs with which the UE is configured are referred to as concurrent MGs or concurrent gaps.

In some embodiments, the at least two MGs with which the UE is configured include at least the first MG and a second MG. The second MG is an MG different from the first MG in the at least two MGs.

In some embodiments, the second MG is a non-associated MG for the MO, which may also be understood as that the MO is not associated with the second MG.

In some embodiments, the second MG is a pre-MG, or the second MG is not a pre-MG. For example, the second MG is an MG that does not need to be activated or deactivated. For example, the second MG is a type-2 MG.

In some embodiments, the type-2 MG includes a “type-2 MG” described in 3GPP R17.

In some embodiments, the type-2 MG includes an MG configured via GapConfig-r17.

In some embodiments, the type-2 MG does not include a pre-MG and a network controlled small gap (NCSG).

In some embodiments, the UE determines that the measurement mode for the MO includes measurement outside gap. This may be understood as that measurement of the MO is not within an MG. This may also be understood as that the MO is measured without using an MG.

In some embodiments, the UE determines that the measurement mode for the MO includes measurement within the second MG. This may be understood as that measurement of the MO is within the second MG. This may also be understood as that the MO is measured by using the second MG.

In some embodiments, no requirement is imposed on the measurement mode for the MO.

In some embodiments, the deactivation of the first MG is triggered by a trigger event.

In some embodiments, the deactivation of the first MG is indicated by second signaling. The second signaling is used to deactivate the first MG.

In some embodiments, the deactivation of the first MG is triggered by second signaling. The second signaling is configured to trigger the UE to deactivate the first MG.

In some embodiments, the trigger event includes at least one of BWP switching, SCell activation, SCell deactivation, SCell addition, SCell release, SCell modification, MO addition, MO modification, or the like.

In summary, in the method according to the embodiments of the present disclosure, the measurement mode for the MO can be determined in a case where the first MG associated with the MO is deactivated, to provide a feasible measurement solution for the UE configured with the at least two MGs.

In some embodiments, process 210 is implemented as process 310. Optionally, in addition to process 310, the measurement method further includes process 330, as shown in FIG. 3.

FIG. 3 is a schematic flowchart of a measurement method according to some exemplary embodiments of the present disclosure. An example in which the method is performed by UE is used for schematic description. The UE may be implemented as the UE 120 shown in FIG. 1. The method includes at least one of the following processes.

In process 310, a measurement mode for an MO is determined in a case where a first MG is deactivated.

The UE is configured with at least two MGs. The at least two MGs include the first MG. The first MG is an associated MG for the MO.

In some embodiments, the measurement mode for the MO is related to at least one of: a type of the first MG;
a type of a second MG;
an overlap status between measurement occasions for the MO and the second MG;
first signaling, wherein the first signaling is used to indicate whether measurement within a non-associated MG is allowed;
first capability information, wherein the first capability information is used to indicate whether measurement within a non-associated MG is supported;
whether measurement of the MO needs an MG; or
a stipulation in a communication protocol.

In some embodiments, a case where the measurement of the MO needs an MG is referred to as a case (a) for short. A case where the measurement of the MO does not need an MG is referred to as a case (b) for short.

In some embodiments, the type of the first MG includes at least one of a per-UE MG or a per-FR MG.

In some embodiments, the second MG is an MG different from the first MG in the at least two MGs.

In some embodiments, the type of the second MG includes at least one of a per-UE MG or a per-FR MG.

In some embodiments, an FR includes an FR1, and/or an FR2, and/or another FR. The FR1 corresponds to 450 MHz to 6 GHz. The FR2 corresponds to 24.25 GHz to 52.6 GHz. Optionally, the FR1 may also be referred to as a sub-6 GHZ band, and the FR2 may also be referred to as a millimeter-wave (mmWave) band. The another FR includes an FR different from the FR1 and the FR2, such as a new frequency band to be allocated in the future, a frequency band different from the FR1 and the FR2 defined in a communication protocol, or the like.

In some embodiments, the overlap status between the measurement occasions for the MO and the second MG includes one of the following three cases:

Case (1): The measurement occasions for the MO do not overlap with the second MG.

Case (2): A part of the measurement occasions for the MO overlap with the second MG.

Case (3): All the measurement occasions for the MO are within the second MG.

For example, as shown in FIG. 4, any measurement occasion for the MO does not overlap with the second MG, which may be understood as that the measurement occasions for the MO do not overlap with the second MG at all.

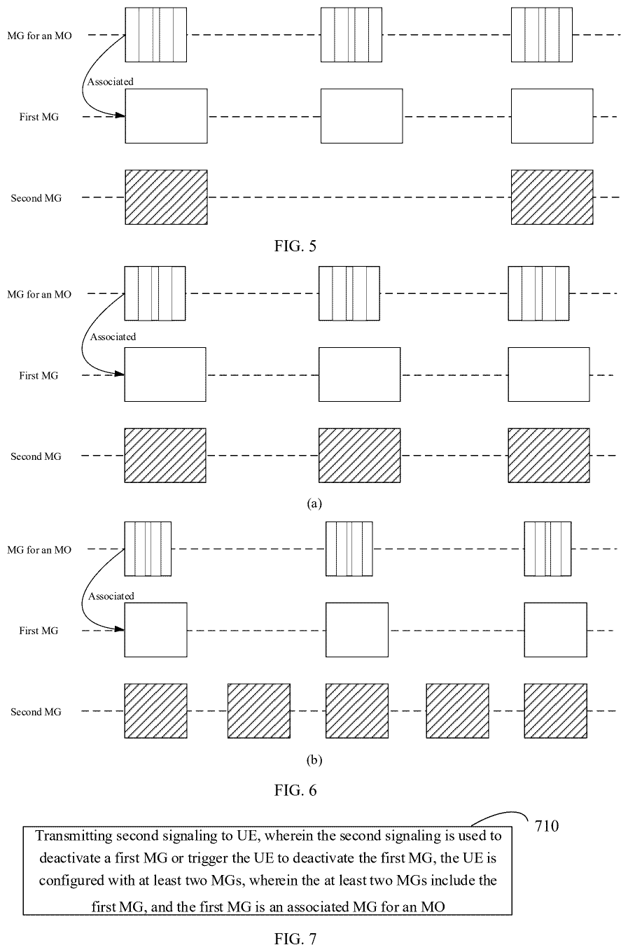

For example, as shown in FIG. 5, a part of the measurement occasions for the MO overlap with the second MG, which may be understood as that the measurement occasions for the MO partially overlap with the second MG.

For example, as shown in FIG. 6, all measurement occasions for the MO overlap with the second MG. All occasions of the second MG may overlap with the measurement occasions for the MO, as shown in FIG. 6(a). Alternatively, a part of the occasions of the second MG may not overlap with the measurement occasions for the MO, as shown in FIG. 6(b). In other words, it is not required that all occasions of the second MG overlap with the measurement occasions for the MO.

In some embodiments, prior to performing process 310, the UE further performs at least one of the following processes:
receiving first signaling, wherein the first signaling is used to indicate whether measurement within a non-associated MG is allowed;
transmitting first capability information, wherein the first capability information is used to indicate whether measurement within a non-associated MG is supported;
receiving second signaling, wherein the second signaling is used to deactivate the first MG or trigger the UE to deactivate the first MG.

In some embodiments, the second signaling is DCI, a medium access control (MAC) control element (CE), or RRC signaling.

In some embodiments, the first signaling satisfies at least one of the following items:
one piece of first signaling is applicable to a plurality of overlap statuses;
one piece of first signaling is applicable to one overlap status;
the first signaling is applicable to both a scenario where measurement of the MO needs an MG and a scenario where measurement of the MO does not need an MG;
the first signaling is applicable only to a scenario where measurement of the MO needs an MG;
the first signaling is applicable only to a scenario where measurement of the MO does not need an MG;
the first signaling is per-UE signaling;
the first signaling is per-FR signaling;
the first signaling is per-MO signaling.

The overlap status is the overlap status between the measurement occasions for the MO and the second MG.

That the first signaling is per-UE signaling may also be understood as that the first signaling is effective for all MOs of the UE. For example, the first signaling is per-UE signaling, the first signaling is used to indicate that all MOs of the UE are allowed to be measured within a non-associated MG, or that all MOs of the UE are not allowed to be measured within a non-associated MG.

That the first signaling is per-FR signaling may also be understood as that the first signaling is effective for all MOs of the UE within a corresponding FR. For example, the first signaling is per-FR1 signaling, the first signaling is used to indicate that all MOs of the UE within the FR1 are allowed to be measured within a non-associated MG, or that all MOs of the UE within the FR1 are not allowed to be measured within a non-associated MG. A case where the first signaling is per-FR2 signaling is similar, and details are not described.

That the first signaling is per-MO signaling may also be understood as that the first signaling is effective only for the MO. For example, the first signaling is per-MO signaling, the first signaling is used to indicate that an MO of the UE is allowed to be measured within a non-associated MG, or that an MO of the UE is not allowed to be measured within a non-associated MG.

In some embodiments, the first signaling includes enableMeasWithNonAssociatedGap signaling.

In some embodiments, a same piece of first signaling is used to indicate whether measurement within a non-associated MG is allowed in all cases.

For example, the same piece of first signaling is used to indicate whether measurement within a non-associated MG is allowed in the following six cases: case (1)+case (a), case (1)+case (b), case (2)+case (a), case (2)+case (b), case (3)+case (a), and case (3)+case (b).

For example, the same piece of first signaling is used to indicate whether measurement within a non-associated MG is allowed in the following four cases: case (2)+case (a), case (2)+case (b), case (3)+case (a), and case (3)+case (b).

For example, the same piece of first signaling is used to indicate whether measurement within a non-associated MG is allowed in the following two cases: case (2)+case (a) and case (3)+case (a). Case (2)+case (b) and case (3)+case (b) are regarded as misconfigurations and do not need to be considered.

In some embodiments, different pieces of first signaling are used to indicate whether measurement within a non-associated MG is allowed in different cases.

For example, four pieces of first signaling are respectively used to indicate whether measurement within a non-associated MG is allowed in the following four cases: case (2)+case (a), case (2)+case (b), case (3)+case (a), and case (3)+case (b).

For example, two pieces of first signaling are respectively used to indicate whether measurement within a non-associated MG is allowed in the following two cases: case (2)+case (a) and case (3)+case (a). Case (2)+case (b) and case (3)+case (b) are regarded as misconfigurations and do not need to be considered.

In some embodiments, the first capability information satisfies at least one of the following items:
one piece of first capability information is applicable to a plurality of overlap statuses;
one piece of first capability information is applicable to one overlap status;
the first capability information is applicable to both a scenario where measurement of the MO needs an MG and a scenario where measurement of the MO does not need an MG.
the first capability information is applicable only to a scenario where measurement of the MO needs an MG.
the first capability information is applicable only to a scenario where measurement of the MO does not need an MG.
the first capability information is per-UE capability information.
the first capability information is per-FR capability information.
the first capability information is per-MO capability information.

The overlap status is the overlap status between the measurement occasions for the MO and the second MG.

In some embodiments, a same piece of first capability information is used to indicate whether measurement within a non-associated MG is supported in all cases.

For example, the same piece of first capability information is used to indicate whether measurement within a non-associated MG is supported in the following six cases: case (1)+case (a), case (1)+case (b), case (2)+case (a), case (2)+case (b), case (3)+case (a), and case (3)+case (b).

For example, the same piece of first capability information is used to indicate whether measurement within a non-associated MG is supported in the following four cases: case (2)+case (a), case (2)+case (b), case (3)+case (a), and case (3)+case (b).

For example, the same piece of first capability information is used to indicate whether measurement within a non-associated MG is supported in the following two cases: case (2)+case (a) and case (3)+case (a). Case (2)+case (b) and case (3)+case (b) are regarded as misconfigurations and do not need to be considered.

In some embodiments, different pieces of first capability information are used to indicate whether measurement within a non-associated MG is supported in different cases.

For example, four pieces of first capability information are respectively used to indicate whether measurement within a non-associated MG is supported in the following four cases: case (2)+case (a), case (2)+case (b), case (3)+case (a), and case (3)+case (b).

For example, two pieces of first capability information are respectively used to indicate whether measurement within a non-associated MG is supported in the following two cases: case (2)+case (a) and case (3)+case (a). Case (2)+case (b) and case (3)+case (b) are regarded as misconfigurations and do not need to be considered.

In some embodiments, the measurement mode for the MO in various cases is stipulated in the communication protocol.

For example, the measurement mode for the MO in one or more of the following six cases is stipulated in the communication protocol: case (1)+case (a), case (1)+case (b), case (2)+case (a), case (2)+case (b), case (3)+case (a), and case (3)+case (b).

For example, the measurement mode for the MO in the following two cases is stipulated in the communication protocol: case (2)+case (a) and case (3)+case (a). Case (2)+case (b) and case (3)+case (b) are regarded as misconfigurations and do not need to be considered.

In some embodiments, in a case where the first MG is deactivated and in a first case, it is determined that the measurement mode for the MO includes measurement outside gap.

In some embodiments, the first case includes at least one of the following items:
the measurement of the MO does not need an MG;
the measurement occasions for the MO do not overlap with the second MG;
a part of the measurement occasions for the MO overlap with the second MG;
the first signaling is used to indicate that measurement within a non-associated MG is not allowed;
the first capability information is used to indicate that measurement within a non-associated MG is not supported;
the first MG is for a first FR, the second MG is for a second FR, and the MO is outside the second FR;
the first MG is an MG for the UE, the second MG is for the first FR, and the MO is outside the first FR.

The first FR is different from the second FR. It should be noted that “first” and “second” herein are merely used for distinguishing description and not intended to limit the FRs.

Optionally, the first FR is the FR1, and the second FR is the FR2. That the first MG is for the first FR may be understood as that the first MG is a per-FR1 MG. That the second MG is for the second FR may be understood as that the second MG is a per-FR2 MG. In a case where the MO is outside the first FR, the MO is outside the FR1, that is, the MO is not within the FR1. In a case where the MO is outside the second FR, the MO is outside the FR2, that is, the MO is not within the FR2.

Optionally, the first FR is the FR2, and the second FR is the FR1. That the first MG is for the first FR may be understood as that the first MG is a per-FR2 MG. That the second MG is for the second FR may be understood as that the second MG is a per-FR1 MG. In a case where the MO is outside the first FR, the MO is outside the FR2, that is, the MO is not within the FR2. In a case where the MO is outside the second FR, the MO is outside the FR1, that is, the MO is not within the FR1.

In some embodiments, that the first MG is an MG for the UE may be understood as that the type of the first MG is a per-UE MG.

In some embodiments, the first case includes at least that the measurement of the MO does not need an MG. Optionally, the first case further includes that the first signaling is used to indicate that measurement within a non-associated MG is not allowed. Optionally, the first case further includes that the first capability information is used to indicate that measurement within a non-associated MG is not supported. Optionally, the first case further includes that the first MG is for the first FR, the second MG is for the second FR, and the MO is outside the second FR. Optionally, the first case further includes that the first MG is an MG for the UE, the second MG is for the first FR, and the MO is outside the first FR.

In some embodiments, the first case includes at least that the measurement of the MO does not need an MG, and that the measurement occasions for the MO do not overlap with the second MG. Optionally, the first case further includes that the first signaling is used to indicate that measurement within a non-associated MG is not allowed. Optionally, the first case further includes that the first capability information is used to indicate that measurement within a non-associated MG is not supported. Optionally, the first case further includes that the first MG is for the first FR, the second MG is for the second FR, and the MO is outside the second FR. Optionally, the first case further includes that the first MG is an MG for the UE, the second MG is for the first FR, and the MO is outside the first FR.

In some embodiments, the first case includes at least that the measurement of the MO does not need an MG, and that a part of the measurement occasions for the MO overlap with the second MG. Optionally, the first case further includes that the first signaling is used to indicate that measurement within a non-associated MG is not allowed. Optionally, the first case further includes that the first capability information is used to indicate that measurement within a non-associated MG is not supported. Optionally, the first case further includes that the first MG is for the first FR, the second MG is for the second FR, and the MO is outside the second FR. Optionally, the first case further includes that the first MG is an MG for the UE, the second MG is for the first FR, and the MO is outside the first FR.

In some embodiments, that the first MG is for the first FR and the second MG is for the second FR may also be understood as that the type of the first MG and the type of the second MG are both per-FR MGs, but the first MG and the second MG are for different FRs.

In some embodiments, that the first MG is an MG for the UE and the second MG is for the first FR may also be understood as that the type of the first MG is a per-UE MG and the type of the second MG is a per-FR MG.

In some embodiments, in a case where the first MG is deactivated and in a second case, it is determined that the measurement mode for the MO includes measurement within the second MG.

In some embodiments, the second case includes at least one of the following items:
the measurement of the MO needs an MG;
the measurement of the MO does not need an MG;
a part of the measurement occasions for the MO overlap with the second MG;
all the measurement occasions for the MO are within the second MG;
the first signaling is used to indicate that measurement within a non-associated MG is allowed;
the first capability information is used to indicate that measurement within a non-associated MG is supported;
the first MG and the second MG are for a same FR;
the first MG and the second MG are both MGs for the UE;
the first MG is for a first FR, and the second MG is an MG for the UE;
the first MG is an MG for the UE, the second MG is for the first FR, and the MO is within the first FR.

The first FR is different from the second FR. It should be noted that “first” and “second” herein are merely used for distinguishing description and not intended to limit the FRs.

Optionally, the first FR is the FR1, and the second FR is the FR2. Optionally, the first FR is the FR2, and the second FR is the FR1.

In some embodiments, the first MG and the second MG are for the same FR. For example, the first MG and the second MG are both for the first FR or the second FR. For example, the first MG is a per-FR1 MG, and the second MG is also a per-FR1 MG. For example, the first MG is a per-FR2 MG, and the second MG is also a per-FR2 MG.

In some embodiments, that the first MG is an MG for the UE may be understood as that the type of the first MG is a per-UE MG. That the second MG is an MG for the UE may be understood as that the type of the second MG is a per-UE MG.

In some embodiments, the second case includes at least that the measurement of the MO does not need an MG, and that a part of the measurement occasions for the MO overlap with the second MG. Optionally, the second case further includes that the first signaling is used to indicate that measurement within a non-associated MG is allowed. Optionally, the second case further includes that the first capability information is used to indicate that measurement within a non-associated MG is supported. Optionally, the second case further includes that the first MG and the second MG are for the same FR. Optionally, the second case further includes that the first MG and the second MG are both MGs for the UE. Optionally, the second case further includes that the first MG is for the first FR, and the second MG is an MG for the UE. Optionally, the second case further includes that the first MG is an MG for the UE, the second MG is for the first FR, and the MO is within the first FR.

In some embodiments, the second case includes at least that the measurement of the MO does not need an MG, and that all the measurement occasions for the MO are within the second MG. Optionally, the second case further includes that the first signaling is used to indicate that measurement within a non-associated MG is allowed. Optionally, the second case further includes that the first capability information is used to indicate that measurement within a non-associated MG is supported. Optionally, the second case further includes that the first MG and the second MG are for the same FR. Optionally, the second case further includes that the first MG and the second MG are both MGs for the UE. Optionally, the second case further includes that the first MG is for the first FR, and the second MG is an MG for the UE. Optionally, the second case further includes that the first MG is an MG for the UE, the second MG is for the first FR, and the MO is within the first FR.

In some embodiments, the second case includes at least that the measurement of the MO needs an MG, and that a part of the measurement occasions for the MO overlap with the second MG. Optionally, the second case further includes that the first signaling is used to indicate that measurement within a non-associated MG is allowed. Optionally, the second case further includes that the first capability information is used to indicate that measurement within a non-associated MG is supported. Optionally, the second case further includes that the first MG and the second MG are for the same FR. Optionally, the second case further includes that the first MG and the second MG are both MGs for the UE. Optionally, the second case further includes that the first MG is for the first FR, and the second MG is an MG for the UE. Optionally, the second case further includes that the first MG is an MG for the UE, the second MG is for the first FR, and the MO is within the first FR.

In some embodiments, the second case includes at least that the measurement of the MO needs an MG, and that all the measurement occasions for the MO are within the second MG. Optionally, the second case further includes that the first signaling is used to indicate that measurement within a non-associated MG is allowed. Optionally, the second case further includes that the first capability information is used to indicate that measurement within a non-associated MG is supported. Optionally, the second case further includes that the first MG and the second MG are for the same FR. Optionally, the second case further includes that the first MG and the second MG are both MGs for the UE. Optionally, the second case further includes that the first MG is for the first FR, and the second MG is an MG for the UE. Optionally, the second case further includes that the first MG is an MG for the UE, the second MG is for the first FR, and the MO is within the first FR.

In some embodiments, that the first MG and the second MG are both MGs for the UE may also be understood as that the type of the first MG and the type of the second MG are both per-UE MGs.

In some embodiments, that the first MG is for the first FR and the second MG is an MG for the UE may also be understood as that the type of the first MG is a per-FR MG and the type of the second MG is a per-UE MG.

In some embodiments, that the first MG is an MG for the UE and the second MG is for the first FR may also be understood as that the type of the first MG is a per-UE MG and the type of the second MG is a per-FR MG.

In some embodiments, in a case where the first MG is deactivated and in a third case, no requirement is imposed on the measurement mode for the MO.

In some embodiments, the third case includes at least one of the following items:
the measurement of the MO does not need an MG;
all the measurement occasions for the MO are within the second MG;
the measurement of the MO needs an MG;
the measurement occasions for the MO do not overlap with the second MG;
a part of the measurement occasions for the MO overlap with the second MG;
the first signaling is used to indicate that measurement within a non-associated MG is not allowed;
the first capability information is used to indicate that measurement within a non-associated MG is not supported;
the first MG is for a first FR, the second MG is for a second FR, and the MO is outside the second FR;
the first MG is an MG for the UE, the second MG is for the first FR, and the MO is outside the first FR.

The first FR is different from the second FR. It should be noted that “first” and “second” herein are merely used for distinguishing description and not intended to limit the FRs.

Optionally, the first FR is the FR1, and the second FR is the FR2. Optionally, the first FR is the FR2, and the second FR is the FR1.

In some embodiments, that the first MG is an MG for the UE may be understood as that the type of the first MG is a per-UE MG.

In some embodiments, the third case includes at least that the measurement of the MO does not need an MG. Optionally, the third case further includes that the first signaling is used to indicate that measurement within a non-associated MG is not allowed. Optionally, the third case further includes that the first capability information is used to indicate that measurement within a non-associated MG is not supported. Optionally, the third case further includes that the first MG is for the first FR, the second MG is for the second FR, and the MO is outside the second FR. Optionally, the third case further includes that the first MG is an MG for the UE, the second MG is for the first FR, and the MO is outside the first FR.

In some embodiments, the third case includes at least that the measurement of the MO does not need an MG, and that all the measurement occasions for the MO are within the second MG. Optionally, the third case further includes that the first signaling is used to indicate that measurement within a non-associated MG is not allowed. Optionally, the third case further includes that the first capability information is used to indicate that measurement within a non-associated MG is not supported. Optionally, the third case further includes that the first MG is for the first FR, the second MG is for the second FR, and the MO is outside the second FR. Optionally, the third case further includes that the first MG is an MG for the UE, the second MG is for the first FR, and the MO is outside the first FR.

In some embodiments, the third case includes at least that the measurement of the MO needs an MG, and that the measurement occasions for the MO do not overlap with the second MG. Optionally, the third case further includes that the first signaling is used to indicate that measurement within a non-associated MG is not allowed. Optionally, the third case further includes that the first capability information is used to indicate that measurement within a non-associated MG is not supported. Optionally, the third case further includes that the first MG is for the first FR, the second MG is for the second FR, and the MO is outside the second FR. Optionally, the third case further includes that the first MG is an MG for the UE, the second MG is for the first FR, and the MO is outside the first FR.

In some embodiments, the third case includes at least that the measurement of the MO needs an MG, and that a part of the measurement occasions for the MO overlap with the second MG. Optionally, the third case further includes that the first signaling is used to indicate that measurement within a non-associated MG is not allowed. Optionally, the third case further includes that the first capability information is used to indicate that measurement within a non-associated MG is not supported. Optionally, the third case further includes that the first MG is for the first FR, the second MG is for the second FR, and the MO is outside the second FR. Optionally, the third case further includes that the first MG is an MG for the UE, the second MG is for the first FR, and the MO is outside the first FR.

In some embodiments, the third case includes at least that the measurement of the MO needs an MG, and that all the measurement occasions for the MO are within the second MG. Optionally, the third case further includes that the first signaling is used to indicate that measurement within a non-associated MG is not allowed. Optionally, the third case further includes that the first capability information is used to indicate that measurement within a non-associated MG is not supported. Optionally, the third case further includes that the first MG is for the first FR, the second MG is for the second FR, and the MO is outside the second FR. Optionally, the third case further includes that the first MG is an MG for the UE, the second MG is for the first FR, and the MO is outside the first FR.

In some embodiments, an MO has a plurality of associated MGs. Use of the plurality of associated MGs is subject to priority. For example, an MO is associated with both a pre-MG 1 and an MG 2. The pre-MG 1 and the MG 2 are in descending order of priority. When the pre-MG 1 is deactivated, in a case where measurement of the MO needs an MG or a measurement occasion for the MO overlaps with the MG 2, the MO may also be measured by using the MG 2.

In process 330, the measurement of the MO is started or restarted based on the measurement mode for the MO.

In some embodiments, in a case where the measurement mode for the MO includes measurement outside gap, the measurement of the MO is started or restarted, and the measurement or restarted measurement of the MO is performed outside gap.

In some embodiments, in a case where the measurement mode for the MO includes measurement within the second MG, the measurement of the MO is started or restarted, and the measurement or restarted measurement of the MO is performed within the second MG.

In some embodiments, in a case where no requirement is imposed on the measurement mode for the MO, the measurement of the MO is not started or restarted, or the measurement of the MO is performed outside gap or within the second MG.

It should be noted that process 330 is optional.

The foregoing processes may be implemented separately or in combination. For example, process 310 is implemented separately as a measurement method. For example, process 330 is implemented separately as a measurement method. For example, processes 310 and 330 are implemented in combination as a measurement method.

In summary, in the method according to the embodiments of the present disclosure, a feasible measurement solution is provided for the UE configured with the at least two MGs. In particular, the measurement mode for the MO may be determined in various cases when the first MG associated with the MO is deactivated. Impact of various factors on the measurement mode is comprehensively considered such that the measurement method according to the embodiments of the present disclosure has high flexibility, feasibility, and robustness.

FIG. 7 is a schematic flowchart of a measurement method according to some exemplary embodiments of the present disclosure. An example in which the method is performed by a network device is used for schematic description. The network device may be implemented as the network device 110 shown in FIG. 1. The method includes at least one of the following processes.

In process 710, second signaling is transmitted to UE. The second signaling is used to deactivate a first MG or trigger the UE to deactivate the first MG. The UE is configured with at least two MGs. The at least two MGs include the first MG. The first MG is an associated MG for an MO.

In some embodiments, the first MG is an associated MG for the MO, which may also be understood as that the MO is associated with the first MG.

In some embodiments, the first MG is a pre-MG.

In some embodiments, the at least two MGs with which the UE is configured are referred to as concurrent MGs or concurrent gaps.

In some embodiments, the at least two MGs with which the UE is configured include at least the first MG and a second MG. The second MG is an MG different from the first MG in the at least two MGs.

In some embodiments, the second MG is a non-associated MG for the MO, which may also be understood as that the MO is not associated with the second MG.

In some embodiments, the second MG is a pre-MG, or the second MG is not a pre-MG. For example, the second MG is an MG that does not need to be activated or deactivated. For example, the second MG is a type-2 MG.

In some embodiments, a measurement mode for the MO includes measurement outside gap. This may be understood as that measurement of the MO is not within gap. This may also be understood as that the MO is measured without gap.

In some embodiments, the measurement mode for the MO includes measurement within the second MG. This may be understood as that measurement of the MO is within the second MG. This may also be understood as that the MO is measured by using the second MG.

In some embodiments, no requirement is imposed on the measurement mode for the MO.

In some embodiments, the measurement mode for the MO is related to at least one of:
a type of the first MG;
a type of the second MG;
an overlap status between measurement occasions for the MO and the second MG;
first signaling, wherein the first signaling is used to indicate whether measurement within a non-associated MG is allowed;
first capability information, wherein the first capability information is used to indicate whether measurement within a non-associated MG is supported;
whether measurement of the MO needs an MG; or
a stipulation in a communication protocol.

In some embodiments, a case where the measurement of the MO needs an MG is referred to as a case (a) for short. A case where the measurement of the MO does not need an MG is referred to as a case (b) for short.

In some embodiments, the overlap status between the measurement occasions for the MO and the second MG includes one of the following three cases:

Case (1): The measurement occasions for the MO do not overlap with the second MG.

Case (2): A part of the measurement occasions for the MO overlap with the second MG.

Case (3): All the measurement occasions for the MO are within the second MG.

In some embodiments, in addition to process 710, the network device further performs one or more of the following processes:
transmitting the first signaling, wherein the first signaling is used to indicate whether measurement within a non-associated MG is allowed;
receiving the first capability information, wherein the first capability information is used to indicate whether measurement within a non-associated MG is supported.

In the embodiments of the present disclosure, an order in which the following three processes are performed is not limited: transmitting the second signaling, transmitting the first signaling, and receiving the first capability information. The order in which the three processes are performed may be adjusted based on an actual situation.

In some embodiments, the second signaling is DCI, a MAC CE, or RRC signaling.

In some embodiments, in a case where the first MG is deactivated and in a first case, the measurement mode for the MO includes measurement outside gap.

In some embodiments, in a case where the first MG is deactivated and in a second case, the measurement mode for the MO includes measurement within the second MG.

In some embodiments, in a case where the first MG is deactivated and in a third case, no requirement is imposed on the measurement mode for the MO.

For related content, reference may be made to process 310. Details are not described herein again.

In summary, in the method according to the embodiments of the present disclosure, a feasible measurement solution is provided for the UE configured with the at least two MGs. In particular, the measurement mode for the MO may be determined in various cases when the first MG associated with the MO is deactivated. Impact of various factors on the measurement mode is comprehensively considered such that the method according to the embodiments of the present disclosure has high flexibility, feasibility, and robustness.

Considering gap combinations with which the UE may be configured, the measurement mode for the MO when the first MG is deactivated after the UE is configured with various gap combinations is further described below by combining the type of the first MG and the type of the second MG mentioned in the embodiments shown in FIG. 3 and FIG. 7 with Table 1 shown above.

1. In a case where a gap combination configuration ID is 0, the UE is configured with two per-FR1 MGs and one per-FR2 MG.

(i) In a case where the first MG is a per-FR1 MG and the second MG is also a per-FR1 MG, the first MG and the second MG are for the same FR, the measurement mode for the MO may include measurement within the second MG, which may also be understood as that the measurement of the MO switches from the first MG to the second MG.

In some embodiments, the measurement mode for the MO includes measurement within the second MG in a case where the first MG and the second MG are for the same FR and at least one of the following conditions is satisfied:
the first signaling is used to indicate that measurement within a non-associated MG is allowed;
the first capability information is used to indicate that measurement within a non-associated MG is supported;
the communication protocol stipulates that the measurement mode for the MO includes measurement within the second MG in a case where the first MG and the second MG are for the same FR;
a part of the measurement occasions for the MO overlap with the second MG;
all the measurement occasions for the MO are within the second MG.

(ii) In a case where the first MG and the second MG are for different FRs, the measurement mode for the MO does not include measurement within the second MG.

The first MG and the second MG are for different FRs. For example, the first MG is a per-FR1 MG, and the second MG is a per-FR2 MG. For another example, the first MG is a per-FR2 MG, and the second MG is a per-FR1 MG.

In some embodiments, no requirement is imposed on the measurement mode for the MO in a case where the first MG is a per-FR1 MG, the second MG is a per-FR2 MG, and the MO is outside the FR2.

In some embodiments, no requirement is imposed on the measurement mode for the MO in a case where the first MG is a per-FR1 MG, the second MG is a per-FR2 MG, the MO is outside the FR2, and the measurement of the MO needs an MG.

In some embodiments, the measurement mode for the MO includes measurement outside gap in a case where the first MG is a per-FR1 MG, the second MG is a per-FR2 MG, the MO is outside the FR2, and the measurement of the MO does not need an MG.

In some embodiments, no requirement is imposed on the measurement mode for the MO in a case where the first MG is a per-FR2 MG, the second MG is a per-FR1 MG, and the MO is outside the FR1.

In some embodiments, no requirement is imposed on the measurement mode for the MO in a case where the first MG is a per-FR2 MG, the second MG is a per-FR1 MG, the MO is outside the FR1, and the measurement of the MO needs an MG.

In some embodiments, the measurement mode for the MO includes measurement outside gap in a case where the first MG is a per-FR2 MG, the second MG is a per-FR1 MG, the MO is outside the FR1, and the measurement of the MO does not need an MG.

2. In a case where a gap combination configuration ID is 1, the UE is configured with one per-FR1 MG and two per-FR2 MGs.

(i) In a case where the first MG is a per-FR2 MG and the second MG is also a per-FR2 MG, the first MG and the second MG are for the same FR, the measurement mode for the MO may include measurement within the second MG, which may also be understood as that the measurement of the MO switches from the first MG to the second MG.

For details about the case where the first MG and the second MG are for the same FR, reference may be made to content of part (i) “in a case where the gap combination configuration ID is 0”. Details are not described herein again.

(ii) In a case where the first MG and the second MG are for different FRs, the measurement mode for the MO does not include measurement within the second MG.

For details about the case where the first MG and the second MG are for different FRs, reference may be made to content of part (ii) “in a case where the gap combination configuration ID is 0”. Details are not described herein again.

3. In a case where a gap combination configuration ID is 2, the UE is configured with two per-UE MGs.

The first MG is one of the per-UE MGs, and the second MG is the other per-UE MG. In this case, the measurement mode for the MO may include measurement within the second MG, which may also be understood as that the measurement of the MO switches from the first MG to the second MG.

In some embodiments, the measurement mode for the MO includes measurement within the second MG in a case where the first MG and the second MG are both per-UE MGs and at least one of the following conditions is satisfied:
the first signaling is used to indicate that measurement within a non-associated MG is allowed;
the first capability information is used to indicate that measurement within a non-associated MG is supported;
the communication protocol stipulates that the measurement mode for the MO includes measurement within the second MG in a case where the first MG and the second MG are both per-UE MGs;
a part of the measurement occasions for the MO overlap with the second MG;
all the measurement occasions for the MO are within the second MG.

4. In a case where a gap combination configuration ID is 3, the UE is configured with one per-FR1 MG and one per-UE MG.

(i) In a case where the first MG is a per-FR1 MG and the second MG is a per-UE MG, the measurement mode for the MO may include measurement within the second MG, which may also be understood as that the measurement of the MO switches from the first MG to the second MG.

In some embodiments, the measurement mode for the MO includes measurement within the second MG in a case where the first MG is a per-FR1 MG, the second MG is a per-UE MG, and at least one of the following conditions is satisfied:
the first signaling is used to indicate that measurement within a non-associated MG is allowed;
the first capability information is used to indicate that measurement within a non-associated MG is supported;
the communication protocol stipulates that the measurement mode for the MO includes measurement within the second MG in a case where the first MG is a per-FR1 MG and the second MG is a per-UE MG;
a part of the measurement occasions for the MO overlap with the second MG;
all the measurement occasions for the MO are within the second MG.

(ii) In a case where the first MG is a per-UE MG and the second MG is a per-FR1 MG, it is necessary to consider whether the MO is within the FR1 when determining the measurement mode for the MO.

In some embodiments, in a case where the first MG is a per-UE MG, the second MG is a per-FR1 MG, and the MO is within the FR1, the measurement mode for the MO may include measurement within the second MG, which may also be understood as that the measurement of the MO switches from the first MG to the second MG.

In some embodiments, the measurement mode for the MO includes measurement within the second MG in a case where the first MG is a per-UE MG, the second MG is a per-FR1 MG, the MO is within the FR1, and at least one of the following conditions is satisfied:
the first signaling is used to indicate that measurement within a non-associated MG is allowed.
the first capability information is used to indicate that measurement within a non-associated MG is supported.
the communication protocol stipulates that the measurement mode for the MO includes measurement within the second MG in a case where the first MG is a per-UE MG, the second MG is a per-FR1 MG, and the MO is within the FR1.
a part of the measurement occasions for the MO overlap with the second MG;
all the measurement occasions for the MO are within the second MG.

In some embodiments, in a case where the first MG is a per-UE MG, the second MG is a per-FR1 MG, and the MO is outside the FR1, the measurement mode for the MO does not include measurement within the second MG, which may also be understood as that the measurement of the MO does not switch from the first MG to the second MG.

In some embodiments, the measurement mode for the MO includes measurement outside gap in a case where the first MG is a per-UE MG, the second MG is a per-FR1 MG, the MO is outside the FR1, and the measurement of the MO does not need an MG.

In some embodiments, no requirement is imposed on the measurement mode for the MO in a case where the first MG is a per-UE MG, the second MG is a per-FR1 MG, the MO is outside the FR1, and the measurement of the MO needs an MG.

5. In a case where a gap combination configuration ID is 4, the UE is configured with one per-FR2 MG and one per-UE MG.

(i) In a case where the first MG is a per-FR2 MG and the second MG is a per-UE MG, the measurement mode for the MO may include measurement within the second MG, which may also be understood as that the measurement of the MO switches from the first MG to the second MG.

In some embodiments, the measurement mode for the MO includes measurement within the second MG in a case where the first MG is a per-FR2 MG, the second MG is a per-UE MG, and at least one of the following conditions is satisfied:
the first signaling is used to indicate that measurement within a non-associated MG is allowed;
the first capability information is used to indicate that measurement within a non-associated MG is supported;
the communication protocol stipulates that the measurement mode for the MO includes measurement within the second MG in a case where the first MG is a per-FR2 MG and the second MG is a per-UE MG;
a part of the measurement occasions for the MO overlap with the second MG;
all the measurement occasions for the MO are within the second MG.

(ii) In a case where the first MG is a per-UE MG and the second MG is a per-FR2 MG, it is necessary to consider whether the MO is within the FR2 when determining the measurement mode for the MO.

In some embodiments, in a case where the first MG is a per-UE MG, the second MG is a per-FR2 MG, and the MO is within the FR2, the measurement mode for the MO may include measurement within the second MG, which may also be understood as that the measurement of the MO switches from the first MG to the second MG.

In some embodiments, the measurement mode for the MO includes measurement within the second MG in a case where the first MG is a per-UE MG, the second MG is a per-FR2 MG, the MO is within the FR2, and at least one of the following conditions is satisfied:
the first signaling is used to indicate that measurement within a non-associated MG is allowed;
the first capability information is used to indicate that measurement within a non-associated MG is supported;
the communication protocol stipulates that the measurement mode for the MO includes measurement within the second MG in a case where the first MG is a per-UE MG, the second MG is a per-FR2 MG, and the MO is within the FR2;
a part of the measurement occasions for the MO overlap with the second MG;
all the measurement occasions for the MO are within the second MG.

In some embodiments, in a case where the first MG is a per-UE MG, the second MG is a per-FR2 MG, and the MO is outside the FR2, the measurement mode for the MO does not include measurement within the second MG, which may also be understood as that the measurement of the MO does not switch from the first MG to the second MG.

In some embodiments, the measurement mode for the MO includes measurement outside gap in a case where the first MG is a per-UE MG, the second MG is a per-FR2 MG, the MO is outside the FR2, and the measurement of the MO does not need an MG.

In some embodiments, no requirement is imposed on the measurement mode for the MO in a case where the first MG is a per-UE MG, the second MG is a per-FR2 MG, the MO is outside the FR2, and the measurement of the MO needs an MG.

6. In a case where a gap combination configuration ID is 5, the UE is configured with one per-FR1 MG, one per-FR2 MG, and one per-UE MG.

(i) In a case where the first MG and the second MG are both per-FR MGs, and the first MG and the second MG are for different FRs, the measurement mode for the MO does not include measurement within the second MG.

For example, the first MG is a per-FR1 MG, and the second MG is a per-FR2 MG. For another example, the first MG is a per-FR2 MG, and the second MG is a per-FR1 MG. For details, reference may be made to content of part (ii) “in a case where the gap combination configuration ID is 0”. Details are not described herein again.

(ii) In a case where the first MG is a per-UE MG and the second MG is a per-FR MG, it is necessary to consider whether the MO is within the FR that the second MG is for when determining the measurement mode for the MO.

For details, reference may be made to content of part (ii) “in a case where the gap combination configuration ID is 3” and content of part (ii) “in a case where the gap combination configuration ID is 4”. Details are not described herein again.

(iii) In a case where the first MG is a per-FR MG and the second MG is a per-UE MG, the measurement mode for the MO may include measurement within the second MG, which may also be understood as that the measurement of the MO switches from the first MG to the second MG.

For details, reference may be made to content of part (i) “in a case where the gap combination configuration ID is 3” and content of part (i) “in a case where the gap combination configuration ID is 4”. Details are not described herein again.

7. In a case where a gap combination configuration ID is 6, the UE is configured with two per-FR1 MGs.

The first MG and the second MG are for the same FR. In this case, the measurement mode for the MO may include measurement within the second MG, which may also be understood as that the measurement of the MO switches from the first MG to the second MG. For details, reference may be made to content of part (i) “In a case where the gap combination configuration ID is 0”. Details are not described herein again.

8. In a case where a gap combination configuration ID is 7, the UE is configured with two per-FR2 MGs.

The first MG and the second MG are for the same FR. In this case, the measurement mode for the MO may include measurement within the second MG, which may also be understood as that the measurement of the MO switches from the first MG to the second MG. For details, reference may be made to content of part (i) “in a case where the gap combination configuration ID is 1”. Details are not described herein again.

It should be noted that factors considered in determining the measurement mode for the MO may be the same or different in the foregoing various cases.

In some embodiments, the measurement mode for the MO in each case is stipulated in the communication protocol.

In some embodiments, the measurement mode for the MO in each case is determined by the UE based on the overlap status between the measurement occasions for the MO and the second MG and whether the measurement of the MO needs an MG.

In some embodiments, the measurement mode for the MO in each case is determined by the UE based on the first signaling and/or the first capability information.

In some embodiments, the measurement mode for the MO in at least one case is stipulated in the communication protocol. The measurement mode for the MO in the other cases is determined by the UE based on one or more of the following factors: the overlap status between the measurement occasions for the MO and the second MG, whether the measurement of the MO needs an MG, the first signaling, the first capability information, the type of the first MG, the type of the second MG, or the like.

For example, the measurement mode for the MO in case (2)+case (a) is stipulated in the communication protocol, and that in the other cases is determined by the UE based on one or more of the foregoing factors.

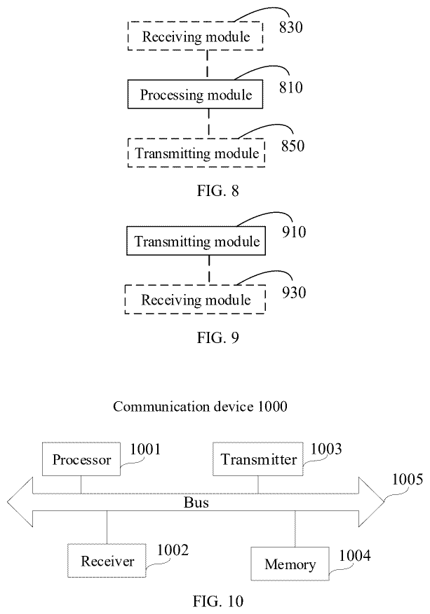

FIG. 8 is a structural block diagram of a measurement apparatus according to some exemplary embodiments of the present disclosure. The apparatus may be implemented as the UE shown in FIG. 2 or FIG. 3 or a part of the UE shown in FIG. 2 or FIG. 3. The UE may be the UE 120 shown in FIG. 1. The apparatus includes a processing module 810. Optionally, the apparatus further includes a receiving module 830 and/or a transmitting module 850.

The processing module 810 is configured to determine a measurement mode for an MO when a first MG is deactivated.

The apparatus is configured with at least two MGs. The at least two MGs include the first MG. The first MG is an associated MG for the MO.

In some embodiments, the measurement mode for the MO is related to at least one of: a type of the first MG; a type of a second MG, wherein the second MG is an MG different from the first MG in the at least two MGs; an overlap status between measurement occasions for the MO and the second MG; first signaling, wherein the first signaling is used to indicate whether measurement within a non-associated MG is allowed; first capability information, wherein the first capability information is used to indicate whether measurement within a non-associated MG is supported; whether measurement of the MO needs an MG; or a stipulation in a communication protocol.

In some embodiments, the overlap status between the measurement occasions for the MO and the second MG includes one of the following: the measurement occasions for the MO do not overlap with the second MG; a part of the measurement occasions for the MO overlap with the second MG; or all the measurement occasions for the MO are within the second MG.

In some embodiments, the measurement mode for the MO includes one of the following items:
in a first case, the measurement mode for the MO includes measurement outside gap;
in a second case, the measurement mode for the MO includes measurement within the second MG; or
in a third case, no requirement is imposed on the measurement mode for the MO.

In some embodiments, the first case includes at least one of the following items:
the measurement of the MO does not need an MG;
the measurement occasions for the MO do not overlap with the second MG;
a part of the measurement occasions for the MO overlap with the second MG;
the first signaling is used to indicate that measurement within a non-associated MG is not allowed;
the first capability information is used to indicate that measurement within a non-associated MG is not supported;
the first MG is for a first FR, the second MG is for a second FR, and the MO is outside the second FR; or
the first MG is an MG for the apparatus, the second MG is for the first FR, and the MO is outside the first FR.

In some embodiments, the second case includes at least one of the following items:
the measurement of the MO needs an MG;
the measurement of the MO does not need an MG;
a part of the measurement occasions for the MO overlap with the second MG;
all the measurement occasions for the MO are within the second MG;
the first signaling is used to indicate that measurement within a non-associated MG is allowed;
the first capability information is used to indicate that measurement within a non-associated MG is supported;
the first MG and the second MG are for a same FR;
the first MG and the second MG are both MGs for the apparatus;
the first MG is for a first FR, and the second MG is an MG for the apparatus; or
the first MG is an MG for the apparatus, the second MG is for the first FR, and the MO is within the first FR.

In some embodiments, the third case includes at least one of the following items:
the measurement of the MO does not need an MG;
all the measurement occasions for the MO are within the second MG;
the measurement of the MO needs an MG;
the measurement occasions for the MO do not overlap with the second MG;
a part of the measurement occasions for the MO overlap with the second MG;
the first signaling is used to indicate that measurement within a non-associated MG is not allowed;
the first capability information is used to indicate that measurement within a non-associated MG is not supported;
the first MG is for a first FR, the second MG is for a second FR, and the MO is outside the second FR; or
the first MG is an MG for the apparatus, the second MG is for the first FR, and the MO is outside the first FR.

In some embodiments, the first signaling satisfies at least one of the following items:
one piece of first signaling is applicable to a plurality of overlap statuses;
one piece of first signaling is applicable to one overlap status;
the first signaling is applicable to both a scenario where measurement of the MO needs an MG and a scenario where measurement of the MO does not need an MG;
the first signaling is applicable only to a scenario where measurement of the MO needs an MG.
the first signaling is applicable only to a scenario where measurement of the MO does not need an MG;
the first signaling is per-apparatus signaling;
the first signaling is per-FR signaling; or
the first signaling is per-MO signaling.

In some embodiments, the first capability information satisfies at least one of the following items:
one piece of first capability information is applicable to a plurality of overlap statuses;
one piece of first capability information is applicable to one overlap status;
the first capability information is applicable to both a scenario where measurement of the MO needs an MG and a scenario where measurement of the MO does not need an MG;
the first capability information is applicable only to a scenario where measurement of the MO needs an MG;
the first capability information is applicable only to a scenario where measurement of the MO does not need an MG;
the first capability information is per-apparatus capability information;
the first capability information is per-FR capability information; or
the first capability information is per-MO capability information.

In some embodiments, the processing module 810 is further configured to start or restart the measurement of the MO based on the measurement mode for the MO.

In some embodiments, the processing module 810 is configured to perform one or more of processes 210, 310, and 330.

In some embodiments, the apparatus further includes the receiving module 830 configured to receive the first signaling.

In some embodiments, the apparatus further includes the transmitting module 850 configured to transmit the first capability information.

In summary, through the apparatus according to the embodiments of the present disclosure, for the UE configured with the at least two MGs, the measurement mode for the MO may be determined in various cases when the first MG associated with the MO is deactivated. Impact of various factors on the measurement mode is comprehensively considered, leading to high flexibility, feasibility, and robustness.

FIG. 9 is a structural block diagram of a measurement apparatus according to some exemplary embodiments of the present disclosure. The apparatus may be implemented as the network device shown in FIG. 7 or a part of the network device shown in FIG. 7. The network device may be the network device 110 shown in FIG. 1. The apparatus includes a transmitting module 910. Optionally, the apparatus further includes a receiving module 930.

The transmitting module 910 is configured to transmit second signaling to UE. The second signaling is used to deactivate a first MG or trigger the UE to deactivate the first MG.

The UE is configured with at least two MGs. The at least two MGs include the first MG. The first MG is an associated MG for the MO.

In some embodiments, a measurement mode for the MO is related to at least one of:
a type of the first MG;
a type of a second MG, wherein the second MG is an MG different from the first MG in the at least two MGs;
an overlap status between measurement occasions for the MO and the second MG;
first signaling, wherein the first signaling is used to indicate whether measurement within a non-associated MG is allowed;
first capability information, wherein the first capability information is used to indicate whether measurement within a non-associated MG is supported;
whether measurement of the MO needs an MG; or
a stipulation in a communication protocol.

In some embodiments, the overlap status between the measurement occasions for the MO and the second MG includes one of the following items:
the measurement occasions for the MO do not overlap with the second MG;
a part of the measurement occasions for the MO overlap with the second MG; or
all the measurement occasions for the MO are within the second MG.

In some embodiments, the measurement mode for the MO includes one of the following items:
in a first case, the measurement mode for the MO includes measurement outside gap;
in a second case, the measurement mode for the MO includes measurement within the second MG. The second MG is an MG different from the first MG in the at least two MGs; or in a third case, no requirement is imposed on the measurement mode for the MO.

In some embodiments, the first case includes at least one of the following items:
the measurement of the MO does not need an MG;
the measurement occasions for the MO do not overlap with the second MG;
a part of the measurement occasions for the MO overlap with the second MG;
the first signaling is used to indicate that measurement within a non-associated MG is not allowed;
the first capability information is used to indicate that measurement within a non-associated MG is not supported;
the first MG is for a first FR, the second MG is for a second FR, and the MO is outside the second FR; or
the first MG is an MG for the UE, the second MG is for the first FR, and the MO is outside the first FR.

In some embodiments, the second case includes at least one of the following items:
the measurement of the MO needs an MG;
the measurement of the MO does not need an MG;
a part of the measurement occasions for the MO overlap with the second MG;
all the measurement occasions for the MO are within the second MG;
the first signaling is used to indicate that measurement within a non-associated MG is allowed;
the first capability information is used to indicate that measurement within a non-associated MG is supported;
the first MG and the second MG are for a same FR;
the first MG and the second MG are both MGs for the UE;
the first MG is for a first FR, and the second MG is an MG for the UE; or
the first MG is an MG for the UE, the second MG is for the first FR, and the MO is within the first FR.

In some embodiments, the third case includes at least one of the following items:
the measurement of the MO does not need an MG;
all the measurement occasions for the MO are within the second MG;
the measurement of the MO needs an MG;
the measurement occasions for the MO do not overlap with the second MG;
a part of the measurement occasions for the MO overlap with the second MG;
the first signaling is used to indicate that measurement within a non-associated MG is not allowed;
the first capability information is used to indicate that measurement within a non-associated MG is not supported;
the first MG is for a first FR, the second MG is for a second FR, and the MO is outside the second FR; or
the first MG is an MG for the UE, the second MG is for the first FR, and the MO is outside the first FR.

In some embodiments, the first signaling satisfies at least one of the following items:
one piece of first signaling is applicable to a plurality of overlap statuses;
one piece of first signaling is applicable to one overlap status;
the first signaling is applicable to both a scenario where measurement of the MO needs an MG and a scenario where measurement of the MO does not need an MG;
the first signaling is applicable only to a scenario where measurement of the MO needs an MG;
the first signaling is applicable only to a scenario where measurement of the MO does not need an MG;
the first signaling is per-UE signaling;
the first signaling is per-FR signaling; or
the first signaling is per-MO signaling.

In some embodiments, the first capability information satisfies at least one of the following items:
one piece of first capability information is applicable to a plurality of overlap statuses;
one piece of first capability information is applicable to one overlap status;
the first capability information is applicable to both a scenario where measurement of the MO needs an MG and a scenario where measurement of the MO does not need an MG;
the first capability information is applicable only to a scenario where measurement of the MO needs an MG;
the first capability information is applicable only to a scenario where measurement of the MO does not need an MG;
the first capability information is per-UE capability information;
the first capability information is per-FR capability information; or
the first capability information is per-MO capability information.

In some embodiments, the transmitting module 910 is configured to perform process 710.

In some embodiments, the apparatus further includes the receiving module 930 configured to receive the first capability information.

In summary, through the apparatus according to the embodiments of the present disclosure, for the UE configured with the at least two MGs, the measurement mode for the MO may be determined in various cases when the first MG associated with the MO is deactivated. Impact of various factors on the measurement mode is comprehensively considered, leading to high flexibility, feasibility, and robustness.

It should be noted that, for the apparatus according to the embodiments described above, the division of the functional modules is merely exemplary. In practice, the functions described above can be assigned to different functional modules as needed; that is, the internal structure of the device can be divided into different functional modules, so as to implement all or a part of the above functions.

With regard to the apparatus in the embodiments, the specific manner in which each module performs operations has been described in detail in the embodiments related to the method and will not be described in detail herein.

FIG. 10 illustrates a schematic structural diagram of a communication device (a UE or a network device) according to some embodiments of the present disclosure. The communication device 1000 includes: a processor 1001, a receiver 1002, a transmitter 1003, a memory 1004, and a bus 1005.

The processor 1001 includes one or more processing cores, and the processor 1001 executes various functional applications and performs information processing by running software programs and modules. In some embodiments, the processor 1001 is configured to implement the functions and processes of the processing module 810 described above.

The receiver 1002 and the transmitter 1003 may be implemented as a communication assembly, which may be a communication chip. In some embodiments, the receiver 1002 is configured to implement the functions and processes of the receiving module 830 or the receiving module 930 as described above. In some embodiments, the transmitter 1003 is configured to implement the functions and processes of the transmitting module 850 and/or the transmitting module 910 as described above.

The memory 1004 is communicably connected to the processor 1001 over the bus 1005. The memory 1004 is configured to store at least one instruction, and the processor 1001 is configured to execute the at least one instruction to perform the processes in the above method embodiments.

In addition, the memory 1004 may be implemented by any type or combination of volatile or non-volatile storage devices including, but not limited to: a magnetic or optical disk, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

In some embodiments, the receiver 1002 independently receives signals/data, or the processor 1001 controls the receiver 1002 to receive signals/data, or the processor 1001 requests the receiver 1002 to receive signals/data, or the processor 1001 cooperates with the receiver 1002 to receive signals/data.

In some embodiments, the transmitter 1003 independently transmits signals/data, or the processor 1001 controls the transmitter 1003 to transmit signals/data, or the processor 1001 requests the transmitter 1003 to transmit signals/data, or the processor 1001 cooperates with the transmitter 1003 to transmit signals/data.

Some embodiments of the present disclosure provide a computer-readable storage medium. The computer-readable storage medium stores at least one program. The at least one program, when loaded and run by the processor, causes the processor to perform the measurement method according to the method embodiments described above.

Some embodiments of the present disclosure provide a chip. The chip includes programmable logic circuitry and/or one or more program instructions. The chip, when running the programmable logic circuitry and/or the one or more program instructions on a communication device, is caused to perform the measurement method according to the method embodiments described above.

Some embodiments of the present disclosure provide a computer program product. The computer program product, when running on a processor of a computer device, causes the computer device to perform the measurement method described above.

Some embodiments of the present disclosure provide a computer program. The computer program includes one or more computer instructions. The one or more computer instructions, when executed by a processor of a computer device, cause the computer device to perform the measurement method described above.

A person skilled in the art shall appreciate that in the foregoing one or more examples, the functions described in the embodiments of the present disclosure may be implemented by hardware, software, firmware, or any combination thereof. The functions, when implemented by software, may be stored in a computer-readable medium or transmitted as one or more instructions or codes on the computer-readable medium. The computer-readable medium includes a computer storage medium and a communication medium. The communication medium includes any medium that facilitates transfer of a computer program from one place to another. The storage medium may be any available medium accessible by a general-purpose computer or a special-purpose computer.

Described above are optional embodiments of the present disclosure, but not intended to limit the present disclosure. Any modifications, equivalent replacements, improvements and the like made within the spirit and principles of the present disclosure should be encompassed within the scope of protection of the present disclosure.

1. A measurement method, performed by a user equipment (UE), the measurement method comprising:
determining a measurement mode for a measurement object (MO) in a case where a first measurement gap (MG) is deactivated;
wherein the UE is configured with at least two MGs, wherein the at least two MGs comprise the first MG, and the first MG is an associated MG for the MO.

2. The measurement method according to claim 1, wherein the measurement mode for the MO is related to at least one of:
a type of the first MG;
a type of a second MG, wherein the second MG is an MG different from the first MG in the at least two MGs;
an overlap status between measurement occasions for the MO and a second MG;
first signaling, wherein the first signaling is used to indicate whether measurement within a non-associated MG is allowed;
first capability information, wherein the first capability information is used to indicate whether measurement within a non-associated MG is supported;
whether measurement of the MO needs an MG; or
a stipulation in a communication protocol.

3. The measurement method according to claim 2, wherein the overlap status between the measurement occasions for the MO and the second MG comprises one of the following items:
the measurement occasions for the MO do not overlap with the second MG;
a part of the measurement occasions for the MO overlap with the second MG; or
all the measurement occasions for the MO are within the second MG.

4. The measurement method according to claim 1, wherein determining the measurement mode for the MO comprises one of:
in a first case, determining that the measurement mode for the MO comprises measurement outside gap;
in a second case, determining that the measurement mode for the MO comprises measurement within a second MG, wherein the second MG is an MG different from the first MG in the at least two MGs; or
in a third case, determining that no requirement is imposed on the measurement mode for the MO.

5. The measurement method according to claim 4, wherein the first case comprises at least one of the following items:
measurement of the MO does not need an MG;
measurement occasions for the MO do not overlap with the second MG;
a part of measurement occasions for the MO overlap with the second MG;
first signaling is used to indicate that measurement within a non-associated MG is not allowed;
first capability information is used to indicate that measurement within a non-associated MG is not supported;
the first MG is for a first frequency range (FR), the second MG is for a second FR, and the MO is outside the second FR; or
the first MG is an MG for the UE, the second MG is for a first FR, and the MO is outside the first FR.

6. The measurement method according to claim 4, wherein the second case comprises at least one of the following items:
measurement of the MO needs an MG;
measurement of the MO does not need an MG;
a part of measurement occasions for the MO overlap with the second MG;
all measurement occasions for the MO are within the second MG;
first signaling is used to indicate that measurement within a non-associated MG is allowed;
first capability information is used to indicate that measurement within a non-associated MG is supported;
the first MG and the second MG are for a same FR;
the first MG and the second MG are both MGs for the UE;
the first MG is for a first frequency range (FR), and the second MG is an MG for the UE; or
the first MG is an MG for the UE, the second MG is for a first FR, and the MO is within the first FR.

7. The measurement method according to claim 4, wherein the third case comprises at least one of the following items:
measurement of the MO does not need an MG;
all measurement occasions for the MO are within the second MG;
measurement of the MO needs an MG;
measurement occasions for the MO do not overlap with the second MG;
a part of measurement occasions for the MO overlap with the second MG;
first signaling is used to indicate that measurement within a non-associated MG is not allowed;
first capability information is used to indicate that measurement within a non-associated MG is not supported;
the first MG is for a first frequency range (FR), the second MG is for a second FR, and the MO is outside the second FR; or
the first MG is an MG for the UE, the second MG is for a first FR, and the MO is outside the first FR.

8. The measurement method according to claim 2, wherein the first signaling satisfies at least one of the following items:
one piece of first signaling is applicable to a plurality of overlap statuses;
one piece of first signaling is applicable to one overlap status;
the first signaling is applicable to both a scenario where measurement of the MO needs an MG and a scenario where measurement of the MO does not need an MG;
the first signaling is applicable only to a scenario where measurement of the MO needs an MG;
the first signaling is applicable only to a scenario where measurement of the MO does not need an MG;
the first signaling is per-UE signaling;
the first signaling is per-FR signaling; or
the first signaling is per-MO signaling.

9. The measurement method according to claim 2, wherein the first capability information satisfies at least one of the following items:
one piece of first capability information is applicable to a plurality of overlap statuses;
one piece of first capability information is applicable to one overlap status;
the first capability information is applicable to both a scenario where measurement of the MO needs an MG and a scenario where measurement of the MO does not need an MG;
the first capability information is applicable only to a scenario where measurement of the MO needs an MG;
the first capability information is applicable only to a scenario where measurement of the MO does not need an MG;
the first capability information is per-UE capability information;
the first capability information is per-FR capability information; or
the first capability information is per-MO capability information.

10. The measurement method according to claim 1, further comprising:
starting or restarting measurement of the MO based on the measurement mode for the MO.

11. A user equipment (UE), comprising:
a processor, a transceiver connected to the processor, and a memory configured to store one or more executable instructions of the processor;
wherein the processor is configured to execute the one or more executable instructions to cause the UE to:
determine a measurement mode for a measurement object (MO) in a case where a first measurement gap (MG) is deactivated;
wherein the UE is configured with at least two MGs, wherein the at least two MGs comprise the first MG, and the first MG is an associated MG for the MO.

12. The UE according to claim 11, wherein the measurement mode for the MO is related to at least one of:
a type of the first MG;
a type of a second MG, wherein the second MG is an MG different from the first MG in the at least two MGs;
an overlap status between measurement occasions for the MO and a second MG;
first signaling, wherein the first signaling is used to indicate whether measurement within a non-associated MG is allowed;
first capability information, wherein the first capability information is used to indicate whether measurement within a non-associated MG is supported;
whether measurement of the MO needs an MG; or
a stipulation in a communication protocol.

13. A network device, comprising:
a processor, a transceiver connected to the processor, and a memory configured to store one or more executable instructions of the processor;
wherein the processor is configured to execute the one or more executable instructions to cause the network device to:
transmit second signaling to a user equipment (UE), wherein the second signaling is used to deactivate a first measurement gap (MG) or trigger the UE to deactivate a first MG;
wherein the UE is configured with at least two MGs, wherein the at least two MGs comprise the first MG, and the first MG is an associated MG for a measurement object (MO).

14. The network device according to claim 13, wherein a measurement mode for the MO is related to at least one of:
a type of the first MG;
a type of a second MG, wherein the second MG is an MG different from the first MG in the at least two MGs;
an overlap status between measurement occasions for the MO and a second MG;
first signaling, wherein the first signaling is used to indicate whether measurement within a non-associated MG is allowed;
first capability information, wherein the first capability information is used to indicate whether measurement within a non-associated MG is supported;
whether measurement of the MO needs an MG; or
a stipulation in a communication protocol.

15. The network device according to claim 13, wherein a measurement mode for the MO comprises one of the following items:
in a first case, the measurement mode for the MO comprises measurement outside gap;
in a second case, the measurement mode for the MO comprises measurement within a second MG, wherein the second MG is an MG different from the first MG in the at least two MGs; or
in a third case, no requirement is imposed on the measurement mode for the MO.

16. The network device according to claim 15, wherein the first case comprises at least one of the following items:
measurement of the MO does not need an MG;
measurement occasions for the MO do not overlap with the second MG;
a part of the measurement occasions for the MO overlap with the second MG;
the first signaling is used to indicate that measurement within a non-associated MG is not allowed;
first capability information is used to indicate that measurement within a non-associated MG is not supported;
the first MG is for a first frequency range (FR), the second MG is for a second FR, and the MO is outside the second FR; or
the first MG is an MG for the UE, the second MG is for a first FR, and the MO is outside the first FR.

17. The network device according to claim 15, wherein the second case comprises at least one of the following items:
measurement of the MO needs an MG;
measurement of the MO does not need an MG;
a part of measurement occasions for the MO overlap with the second MG;
all measurement occasions for the MO are within the second MG;
first signaling is used to indicate that measurement within a non-associated MG is allowed;
first capability information is used to indicate that measurement within a non-associated MG is supported;
the first MG and the second MG are for a same FR;
the first MG and the second MG are both MGs for the UE;
the first MG is for a first frequency range (FR), and the second MG is an MG for the UE; or
the first MG is an MG for the UE, the second MG is for a first FR, and the MO is within the first FR.

18. The network device according to claim 15, wherein the third case comprises at least one of the following items:
measurement of the MO does not need an MG;
all measurement occasions for the MO are within the second MG;
measurement of the MO needs an MG;
measurement occasions for the MO do not overlap with the second MG;
a part of the measurement occasions for the MO overlap with the second MG;
first signaling is used to indicate that measurement within a non-associated MG is not allowed;
first capability information is used to indicate that measurement within a non-associated MG is not supported;
the first MG is for a first frequency range (FR), the second MG is for a second FR, and the MO is outside the second FR; or
the first MG is an MG for the UE, the second MG is for a first FR, and the MO is outside the first FR.

19. The network device according to claim 14, wherein the first signaling satisfies at least one of the following:
one piece of first signaling is applicable to a plurality of overlap statuses;
one piece of first signaling is applicable to one overlap status;
the first signaling is applicable to both a scenario where measurement of the MO needs an MG and a scenario where measurement of the MO does not need an MG;
the first signaling is applicable only to a scenario where measurement of the MO needs an MG;
the first signaling is applicable only to a scenario where measurement of the MO does not need an MG;
the first signaling is per-UE signaling;
the first signaling is per-FR signaling; or
the first signaling is per-MO signaling.

20. The network device according to claim 14, wherein the first capability information satisfies at least one of the following items:
one piece of first capability information is applicable to a plurality of overlap statuses;
one piece of first capability information is applicable to one overlap status;
the first capability information is applicable to both a scenario where measurement of the MO needs an MG and a scenario where measurement of the MO does not need an MG;
the first capability information is applicable only to a scenario where measurement of the MO needs an MG;
the first capability information is applicable only to a scenario where measurement of the MO does not need an MG;
the first capability information is per-UE capability information;
the first capability information is per-FR capability information; or
the first capability information is per-MO capability information.
